(19) United States
(12) Patent Application Publication
(10) Pub. No.: US 2002/0077396 A1
(43) Pub. Date: Jun. 20, 2002

(54) Polypropylene resin composition

(76) Inventors: Young-Hwan Yu, Ulsan (KR); Su-Youl Kim, Seosan-si (KR); Dong-Myung Shin, Seosan-si (KR)

Correspondence Address: CHRISTIE, PARKER & HALE, LLP, P.O. BOX 7068, PASADENA, CA, 91109-7068, US

(21) Appl. No.: 10/002,452

(22) Filed: Nov. 1, 2001

(30) Foreign Application Priority Data
Nov. 1, 2000 (KR) 2000-64691

(51) Int. Cl. C08K 5/20

(52) U.S. Cl. 524/232; 524/445; 524/451; 524/515; 524/315; 524/318

(57) ABSTRACT

The present invention relates to a polypropylene resin composition and more particularly, to the polypropylene resin composition comprising a high crystalline polypropylene, a polypropylene or polyethylene having low molecular weight, an inorganic filler and an anti-additive. The polypropylene resin of the present invention provides improved heat resistance, impact resistance and scratch resistance, so that it is suitable for substituting conventional polypropylenes used for automotive interior materials having several tens of grades, and further lowers manufacturing cost along with improving productivity and reclamation of used materials.

### BACKGROUND OF THE INVENTION

1. Field of the Invention

The present invention relates to a polypropylene resin composition and more particularly, to the polypropylene resin composition comprising a high crystalline polypropylene, a polypropylene or polyethylene having low molecular weight, an inorganic filler and an anti-additive. The polypropylene resin of the present invention provides improved heat resistance, impact resistance and scratch resistance, so that it is suitable for substituting conventional polypropylenes used for automotive interior materials having several tens of grades, and further lowers manufacturing cost along with improving productivity and reclamation of used materials.

Recently, researches have been highly increased to replace engineering resins, i.e. expensive ABS/PC, ABS and PPF, with inexpensive general-purpose resins. For this purpose, a polypropylene resin as one of general-purpose resins was introduced to replace the engineering resin because it has well-balanced molecular structure and provides excellent rigidity and hinge property with low price. However, there are some drawbacks to use such a polypropylene resin in automotive interior materials due to deficient in heat resistance, impact strength and scratch resistance, resulting in the production of inferior goods having thermal deformation and scratches and the formation of cracks by external impact. And further, molecular weight remarkably decreases due to the thermal deformation during an injection molding process at a temperature of over 280° C. Such problems indicate that use of the conventional polypropylene resins is limited for high functionalities of automotive interior parts due to its inferior properties. Since conventional polypropylene resins used for automotive interior materials require several tens of grades to satisfy the qualities and physical properties, color matching becomes poor and a resin inside an injection mold has to be changed with changing of a different grade resin during the process, resulting in deterioration of processability and efficiency and rising manufacturing cost. In terms of reclamation, the recycling cost becomes high and the physical properties of reclaimed products become poor, so that it deteriorates its commercial value.

Recently, Toyota motor company has developed a polypropylene resin which integrates polypropylene resins graded into several tens to one grade for interior automotive materials. This development stands high in estimation because a separation process according to the grade becomes unnecessary, it lowers the manufacturing cost, the physical properties of reclaimed products are improved and commercial value becomes better.

### SUMMARY OF THE INVENTION

Consequently, an object of the present invention is to provide a polypropylene resin composition comprising a high crystalline polypropylene, a polypropylene or polyethylene with low molecular weight, an inorganic filler and an anti-additive to have advantages over the above-mentioned polypropylene resins in that it exhibits excellent impact strength, heat resistance by improving heat distortion temperature and durability to minimize scratches and cracks, it lowers the manufacturing cost, it enhances processability by integrating graded polypropylene resins to one, and it improves color matching and physical properties of reclaimed materials, so that it can be suitable for interior automotive pillar and trim parts.

### DETAILED DESCRIPTION OF THE INVENTION

The present invention provides a polypropylene resin composition comprising 50-90wt. % of a high crystalline polypropylene, 5-50wt. % of polypropylene or polyethylene having low molecular weight, 0.1-3wt. % of an inorganic filler, and 0.1-0.5 wt. % of an anti-additive.

The present invention is described in detail as set forth hereunder.

The present invention is characterized by a polypropylene resin composition comprising a high crystalline polypropylene as one of components selected from the group consisting of a high crystalline propylene homopolymer having propylene monomers as a main component, an ethylene-propylene block copolymer having ethylenes and a mixture thereof.

The high crystalline polypropylene used in the polypropylene resin composition provides excellent durability and scratch resistance due to high crystallinity. The high crystalline polypropylene used in the present invention has pentad fraction (% mmmm) measured by ¹³C-NMR higher than 97% and melt index of 0.5-50 g/10 min. The high crystalline polypropylene is used in 50-90 wt. % of the entire polypropylene resin composition, preferably in 70-80 wt. %. If the content exceeds 90 wt. %, the impact resistance and scratch resistance become degraded because it requires high fluidity having a melt index of over 12; otherwise if it is below 50wt. %, the scratch resistance and modulus of bending elasticity are degraded. The high crystalline ethylene-propylene block copolymer of the present invention is preferred to contain 3-10 wt. % of an ethylene content.

Polypropylene or polyethylene having low molecular weight of the present invention is used to provide better flowabilty of resins during molding process and complement poor impact strength at a low temperature. The polypropylene can be propylene homopolymer, ethylene-propylene block copolymer, or a mixture thereof having a melt index of 0.5-50 g/10 min. A polypropylene having low molecular weight is used to provide improved impact strength of the resultant polypropylene resin composition in case of low melt index and improved flowability in case of high melt index. The polypropylene having low molecular weight is used in 5-50 wt. % of the entire polypropylene resin composition, preferably in 20-30 wt. %. If the content exceeds 50 wt. %, the impact resistance and scratch resistance become degraded; otherwise if it is below 5 wt. %, the flowability becomes inferior.

Polyethylene of the present invention is used to complement poor impact strength of the polypropylene resin composition at a low temperature and is preferred to have a melt index of 1-25 g/10 min and a specific gravity of 0.915-0.964. The polyethylene is used in 5-50 wt. % of the entire polypropylene resin composition, preferably in 20-30 wt. %. If the content exceeds 50 wt. %, the scratch resistance becomes degraded; otherwise if it is below 5 wt. %, the impact strength becomes inferior.

An inorganic filler as another component of the polypropylene resin composition acts as a nucleating agent to improve scratch resistance and rigidity and provides lower manufacturing cost and crosslinking effect. Particles of the inorganic filler are preferred to have spherical shape and small size on the purpose of increasing surface tension of particles to improve rigidity of the composition. The average particle size is preferred to be in the range of 1-4 μm. If the particle size is larger than 4 μm, cracks can be produced around the particles and elongation becomes inferior; otherwise if it is smaller than 1 μm, distribution of the resin may be degraded with conventional compounding method. Said inorganic filler is used in the range of from 0.1 to 3 wt. % to the entire polypropylene resin composition. When it is less than 0.1 wt. %, it is not enough to act as a nucleating agent to improve scratch resistance and rigidity. On the other hand, when it is more than 3 wt. %, the elongation becomes inferior. Said inorganic filler can be talc, wollastonite, or a mixture thereof.

An anti-additive of the present invention is used to provide excellent fowability and scratch resistance of the polypropylene resin composition of the present invention. The anti-additive can be fatty acid, fatty acid amide, monoester or glycerin mono-stearate containing 40-95 wt. % of a mixture thereof. Said anti-additive is used in the range of from 0.1 to 0.5 wt. % to the entire polypropylene resin composition. When it is less than 0.1 wt. %, flowability becomes degraded. On the other hand, when it is more than 0.5 wt. %, scratch resistance does not increase further.

Besides these components, an elastomer may be incorporated in the range of 1-2 wt. %, if desired. Examples of the elastomer are ethylene-propylene elastomer (EPR), ethylene-propylene-diene elastomer (EPDM), polyethylene prepared using a metallocene catalyst, or a mixture thereof. Other additives, used by one having ordinary skill in the art, such as an anti-oxidant, a heat stabilizer, and a TV stabilizer may be arbitrarily incorporated in an appropriate content not to obstruct the above-mentioned object of the present invention.

The polypropylene resin composition of the present invention is prepared by mixing and compounding a mixture of a high crystalline polypropylene, a polypropylene or polyethylene having low molecular weight, an inorganic filler, an anti-additive, and other additives and the prepared polypropylene resin composition is then palletized and molded by the means of injection molding to produce desired automotive parts such as pillar and trim parts. Therefore, use of the polypropylene resin composition of the present invention instead of conventional polypropylene resin graded to several tens improves sharply a manufacturing process and controlling the resin, color matching and physical properties of reclaimed materials with lowering the manufacturing cost.

Hereunder is given a more detailed description of the present invention using examples. However, it should not be construed as limiting the scope of this invention.

### EXAMPLES 1-3

A mixture of high crystalline polypropylene, polypropylene or polyethylene having low molecular weight, inorganic filler and anti-additive was mixed with listed amount and ratio in Table 1 and compounded at 180-230° C. The resulting mixture was melt-kneaded with twin-screw extruder, palletized, and molded by injection molding machine to obtain test specimen.

TABLE 1

| | Example (wt. %) | | |
|---|---|---|---|
| Composition | 1 | 2 | 3 |
| High crystalline polypropylene¹⁾ | 79.3 | 50 | 89.3 |
| Propylene homopolymer | 20²⁾ | 49.2³⁾ | — |
| Ethylene-propylene block copolymer⁴⁾ | — | — | 10 |
| Inorganic filler⁵⁾ | 0.3 | 0.5 | 0.4 |
| Anti-additive⁶⁾ | 0.4 | 0.3 | 0.3 |

¹⁾melt index = 10 g/10 min
²⁾melt index = 25 g/10 min
³⁾melt index = 17 g/10 min
⁴⁾melt index = 36 g/10 min
⁵⁾inorganic filler talc
⁶⁾anti-additive fatty acid amide

The ethylene content contained in high crystalline polypropylene is measured by means of using FT-IR spectrometer.

Experimental example

Physical properties of the polypropylene resin composition prepared from Examples 1-3 were tested by the following method. The result is shown in Table 2.

[Test Method]

A. Melt index (MI, g/10 min): Tested with ASTM D1238 (230° C./2.16 kg)

B. Special gravity (g/ml): Tested with ASTM D791

C. Tensile strength (kg/cm³) and Elongation (%): Tested with ASTM

D638 (thickness of the specimen 3 mm, 23° C.)

D. Modulus of bending elasticity (kg/cm³): Tested with ASTM D79 (thickness of the specimen 3 mm, 23° C.)

E. IZOD Impact strength (kg·cm/cm²): Tested with ASTM D256 (thickness of the specimen 3 mm, 23° C.)

F. Thermal deformation temperature (°C.): Tested with ASTM D648 (4.6 kg loaded, thickness of the specimen 3 mm)

G. Lead hardness of pencil: Tested with JIS K-0202

TABLE 2

| | Example | | |
|---|---|---|---|
| Items | 1 | 2 | 3 |
| Melt index (MI, g/10 min) | 12.1 | 13 | 12.2 |
| Special gravity (g/ml) | 0.91 | 0.91 | 0.91 |
| Tensile strength (kg/cm³) | 344 | 350 | 332 |
| Elongation (%) | >500 | 500 | >500 |
| Modulus of bending elasticity | 22,117 | 20,412 | 21,034 |
| (kg/cm³) | | | |
| IZOD Impact strength (kg.cm/cm²) | 12.1 | 10.2 | 13.6 |
| Thermal deformation temperature | 137 | 138 | 136 |
| (° C.) | | | |
| Lead hardness of pencil | 3B | 3B | 3B |

As shown in table 2, the polypropylene resin composition of the present invention provides superior scratch resistance, impact strength and heat resistance to those of the conventional polypropylene resin compositions.

According to the present invention, as described above, the polypropylene resin composition has sufficient scratch resistance, impact strength and heat resistance, so that it has excellent properties satisfactorily to fit for use in interior automotive parts such as pillar and trim parts.

What is claimed is:

1. A polypropylene resin composition comprising 50-90 wt. % of a high crystalline polypropylene, 5-50 wt. % of polypropylene or polyethylene having low molecular weight, 0.1-3 wt. % of an inorganic filler, and 0.1-0.5 wt. % of an anti-additive.

2. The polypropylene resin composition according to claim 1, wherein said high crystalline polypropylene is selected from the group consisting of propylene homopolymer, ethylene-propylene block copolymer and a mixture thereof having pentad fraction (%mmmm) measured by ¹³C-NMR higher than 97% and melt index of 0.5-50 g/10 min.

3. The polypropylene resin composition according to claim 1 or claim 2, wherein said ethylene-propylene block copolymer contains 3-10 wt. % of an ethylene content.

4. The polypropylene resin composition according to claim 1, wherein said polypropylene having low molecular weight has melt index of 0.5-50 g/10 min and is selected from the group consisting of a propylene homopolymer, an ethylene-propylene block copolymer and a mixture thereof.

5. The polypropylene resin composition according to claim 1, wherein said polyethylene having low molecular weight has melt index of 1-25 g/10 min.

6. The polypropylene resin composition according to claim 1, wherein said inorganic filler has an average particle size of 1-4 μm and is selected from the group consisting of talc, wollastonite, and a mixture thereof.

7. The polypropylene resin composition according to claim 1, wherein said anti-additive is selected from the group consisting of fatty acid, fatty acid amide, monoester, and glycerin mono-stearate containing 40-95 wt. % of a mixture thereof.
